(19) United States
(12) Patent Application Publication
(10) Pub. No.: US 2013/0152643 A1
(43) Pub. Date: Jun. 20, 2013

(54) LOCKING ARRANGEMENT

(71) Applicant: David Martin Stuckey, Hawthorn (AU)

(72) Inventor: David Martin Stuckey, Hawthorn (AU)

(73) Assignee: DAVID STUCKEY INVESTMENTS PTY LTD., Melbourne, Victoria (AU)

(21) Appl. No.: 13/818,614

(22) PCT Filed: Aug. 22, 2011
(86) PCT No.: PCT/AU11/01073

§ 371 Date: Feb. 22, 2013

(30) Foreign Application Priority Data
Aug. 24, 2010 (AU) 2010903781

(51) Int. Cl. E05B 65/12

(52) U.S. Cl. CPC E05B 81/16
USPC 70/275

(57) ABSTRACT

A locking arrangement comprising: a handle assembly; a primary locking mechanism comprising a locking bar having a first shoulder and a second shoulder, which bar is movable between an extended locking position and a retracted release position, whereby when the locking bar is in the retracted release position, the handle assembly is movable “between a latched condition and an unlatched condition; a secondary locking mechanism having an override means, wherein when the override means is independently urged against the first and/or second shoulder of the locking bar, the locking bar is reversibly movable between the extended locking position and the retracted release position; and a biased catch means to releasably retain the locking bar in either the extended locking position or the retracted release position.

### FIELD OF THE INVENTION

The present invention relates to a locking arrangement, preferably a locking arrangement for use with a lockable access point, such as a door, storage container, compartment, cover/hatch, transport box and bag and the like, on a vehicle including a motor vehicle or a motor cycle. The invention particularly relates to a locking arrangement, whereby a primary locking mechanism can be overridden by a secondary locking mechanism.

### BACKGROUND OF THE INVENTION

Transport/delivery trucks arc often configured for security reasons with enclosed rear van areas, whereby access to the goods located therein is via one or more lockable doors. Similarly, recreational vehicles including mobile homes often contain hollow compartments that act as storage areas, where access to the inside of the compartment is via at least one door or hatch located on the outside of the vehicle's body.

A tradesperson's vehicle in the form of a motor vehicle utility often has one or more toolboxes or storage containers mounted on the utility's tray in which the tradesperson will store his/her tools. Sometimes, the open tray area of the utility can be covered with a solid hatch to protect and secure cargo thereunder. Furthermore, motorcyclists will often have saddlebags affixed to either side of the motorcycle frame for carrying items therein as they travel around.

As the cargo inside each of these storage areas is valuable to its owner, there is a need to prevent unauthorized access to such access points when the owner leaves the vehicle and as a result, the above doors, compartments, boxes, containers, covers and bags are usually lockable.

The invention will be more particularly described herein with respect to one or more door/s on an enclosed van of a truck. However, the invention has general applicability as detailed above.

The present invention seeks to provide an improved locking arrangement. More particularly, the present invention provides a locking arrangement, which seeks to minimize or ameliorate the disadvantages of the prior art. For example, most modem vehicles, particularly trucks and motor cars and even motorcycles, have central locking facilities wherein, through activation of a suitable actuator via a remote control device or via the vehicle's own key, the vehicle's lockable doors can be individually in some cases or all in most cases be locked and unlocked simultaneously. However, it would still be preferable to be able to individually lock or unlock each locking means either via a key or via the central locking system.

### SUMMARY OF THE INVENTION

According to the present invention, there is provided a locking arrangement comprising: a) a handle assembly; b) a primary locking mechanism comprising a locking bar having a first shoulder and a second shoulder, which bar is movable between an extended locking position and a retracted release position whereby, when the locking bar is in the retracted release position, the handle assembly is movable between a latched condition and an unlatched condition; c) a secondary locking mechanism having an override means, wherein when the override means is independently urged against the first and/or second shoulder of the locking bar, the locking bar is reversibly movable between the extended locking position and the retracted release position; and d) a biased catch means to releasably retain the locking bar in either the extended locking position or the retracted release position.

The locking bar preferably further comprises a cut-out region to substantially receive the override means therein.

Preferably, the primary locking mechanism further comprises an actuator means which acts upon the locking bar to move the locking bar between the extended locking position and the retracted release position.

The locking bar more preferably further comprises a first catch means interaction zone and a second catch means interaction zone, wherein, when the locking bar is in the extended locking position, the biased catch means interacts with the first catch means interaction zone to releasably retain the locking bar in the extended locking position, and when the locking bar is in the retracted release position, the biased catch means interacts with the second catch means interaction zone to releasably retain the locking bar in the retracted release position.

In one preferred embodiment of the present invention, the handle assembly comprises a handle, a handle shaft, a slotted disc and a latching cam, wherein the handle, the slotted disc and the latching cam arc mountable or fixable to the handle shaft so that rotation of the handle results in concomitant rotation of the slotted disc and latching cam. Preferably, the slotted disc comprises one or more regions, preferably a slot/s, with which the locking bar engages when in the extended locking position.

Preferably further, the secondary locking mechanism is a keyed lock. Preferably, the cut-out region is, in one form of the invention, substantially ovoid-shaped. When the override means of the secondary locking mechanism is substantially received into the cut-out region, reversible movement of the locking bar between the extended engagement position and the retracted release position is enabled. In another preferred form of the invention, the locking bar is adapted to cooperate with the secondary locking mechanism by the inclusion of a first and second shoulder against which the override means is preferably urgable to reversibly move the locking bar between the extended locking position and the retracted release position.

In one preferred embodiment of the invention, the secondary locking mechanism is a keyed lock which comprises a biasing means to return the secondary locking mechanism to a reset position after the override means has been urged against the first or second shoulder of the locking bar. Preferably, when the secondary locking mechanism is in the reset position, the key is removable therefrom.

The preferred handle assembly is in the form of a T-handle assembly, wherein the T-handle is mounted in a supporting dish. In a more preferred form, the T-handle member is foldable and receivable in the dish, so as to minimize its protrusion out of a planar surface onto which the assembly is mounted.

In certain embodiments of the present invention, the T-handle assembly further comprises an engagement means, wherein the engagement means releasably engages the T-handle member with the supporting dish when the T-handle assembly is in a closed condition following which the T-handle portion does not substantially protrude from the planar surface onto which the assembly is mounted.

The engagement means is preferably as simple as relying upon a snap- or quick-fit engagement or even magnetic attraction between associated parts or through a friction fit. The snap- or quick-fit engagement means preferably comprises a suitably shaped female member positioned an the floor of the supporting dish or, in an alternative embodiment, on the underside of the T-handle member. The snap- or quick-fit engagement means further comprises a male member which is releasably receivable within the suitably shaped female member, and which is located on the underside of the T-handle member, or in the above alternative embodiment, on the floor of the supporting dish itself. In a preferred form, when the female member is positioned on the underside of the T-handle member, the position of the cooperating male member is aligned therewith on the supporting dish. However, when the female member is located on the supporting dish, the male member is aligned with and positioned on the underside of the T-handle member, The male member can be as simple as a threaded fastener, having a suitably shaped head. The female member preferably comprises a substantially obconic recess formed within a suitable receiving means and into which recess the male member is able to be releasably received and held. The male member, preferably a threaded fastener, is more preferably releasably secured to the supporting dish. When the female member is positioned on the supporting dish, it is preferably releasably secured thereto via a suitable fastening means such as a threaded bolt, preferably having a countersunk head, which bolt is receivable within the recess and is thus able to be screwed and held in position on the supporting dish. Instead of the snap- or quick-fit arrangement, one or more, preferably a pair of, suitable magnets act as engagement means. One or more of these are preferably provided and affixed to the relevant underside of the T-handle member and as a plate affixed to the floor of the supporting dish. The engagement means further preferably incorporate/s a combination of these preferred arrangements

### DESCRIPTION OF THE DRAWINGS

Other features and advantages of one or more preferred embodiments of the present invention will be readily apparent to one of ordinary skill in the art from the following written description with reference to, and used in conjunction with, the accompanying drawings.

FIG. 1 is a perspective front view of one embodiment of the locking arrangement of the present invention in a latched condition (1a) and an unlatched condition (1b).

FIG. 2 is a perspective rear view of the embodiment illustrated in FIG. 1, with a cover removed for clarity.

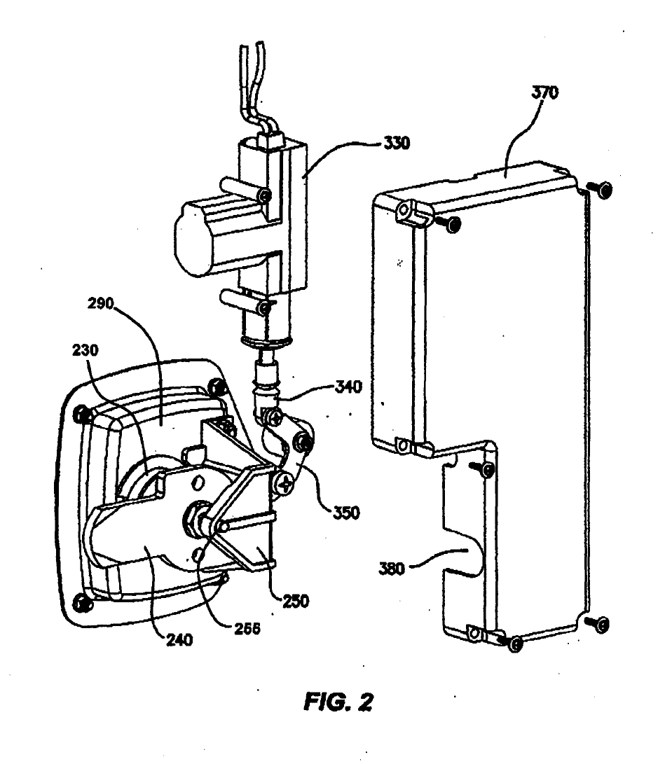

FIG. 3 is a partially exploded perspective rear view of an embodiment of a locking arrangement according to the present invention, showing the primary and secondary locking mechanisms and locking bar of the present invention.

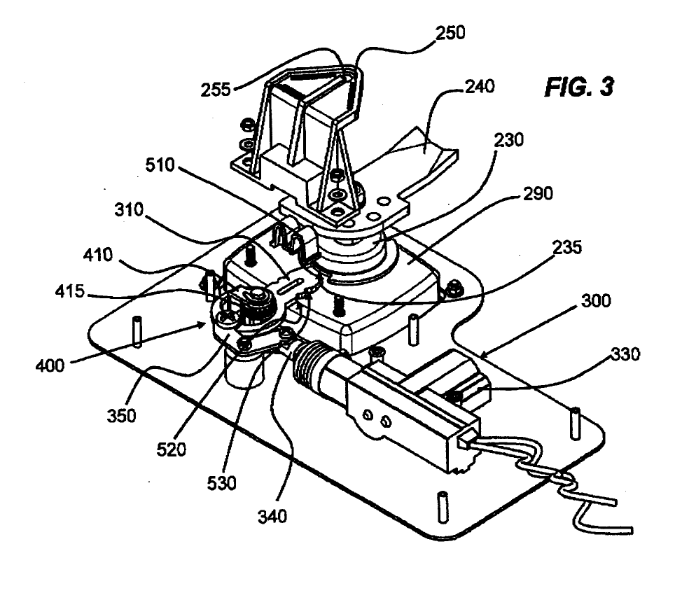

FIG. 4 shows how, in one particular embodiment of the present invention, the secondary locking mechanism is able to act to move the locking bar between an extended locking position (A) and a retracted release position (C). Also shown, is the secondary locking mechanism in a reset position, when the locking bar is in either an extended locking position (B) or a retracted release position (D).

FIG. 5 shows the embodiment shown in FIG. 3 in assembled form as well as detail of the support bracket, biased catch means and locking bar of this preferred embodiment.

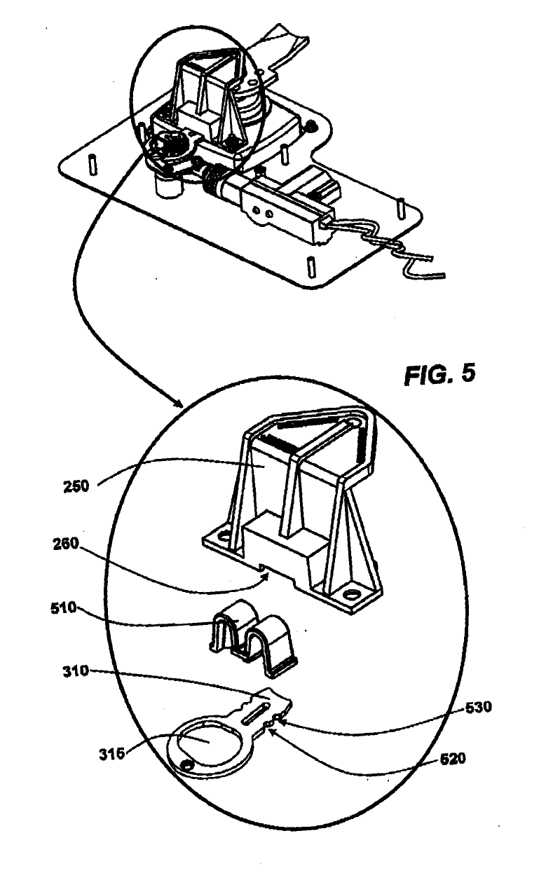

FIG. 6 shows detail of one form of an engagement means used to releasably engage the handle member with the dish, according to an embodiment of the present invention.

### DETAILED DESCRIPTION OF THE INVENTION

Referring to all the drawings wherein like reference numerals designate like or corresponding parts throughout the several views, the following description refers to the specific, illustrated embodiments of the present invention and is in no way intended to limit the scope of the present invention to the specific, illustrated embodiments.

The illustrated embodiments of a locking arrangement 100 of the present invention comprise a lockable T-handle assembly 200 having a primary 300 and a secondary 400 locking mechanism. Each of the primary 300 and secondary 400 locking mechanisms are used independently to move a locking bar 310 between an extended locking position and a retracted release position.

The T-handle assembly 200 comprises a handle 210 attached to a handle shaft 220, such that rotation of the handle 210 results in concomitant rotation of the handle shaft 220. Mounted on or fixed to the shaft 220 is a slotted disc 230 and latching cam 240, which are also caused to rotate upon rotation of the handle 210. Assuming that the assembly 200 is mounted on the surface of a door (not shown), the latching cam 240 is intended to engage with a catch means (not shown), such as an opening on the door frame into which the door will fit and into which the catch means is received, thereby enabling the door to remain closed. Rotation of the handle 210 results in rotation of the latching cam 240, whereby the latching cam 240 moves out of engagement with the catch means, thereby allowing the door to be opened. The slotted disc 230 comprises one or more region/s, preferably a slot/s 235, with which the locking bar 310 is engageable. Therefore, the locking bar 310 is movable relative to the slot 235 between an extended locking position and a retracted release position. When the locking bar 310 is in the extended locking position, i.e. received into the slot 235 in slotted disc 230, the handle 210 cannot be rotated and the latching cam 240 remains engaged with the catch means. In this way, the T-handle assembly 200 is placed in a locked condition via locking bar 310.

The retracted release position is where the locking bar 310 is withdrawn from the slot 235 in slotted disc 230, whereby the handle 210 is rotatable and the T-handle assembly 200 is thereby placed in an unlatched condition. It is preferred that the locking bar 310 is movable in a plane substantially perpendicular to the axis of rotation of the handle shaft 220. In order to provide stability and guidance for movement of the locking bar 310, there is provided a support bracket 250. In certain preferred embodiments of the present invention, the support bracket 250 provides a support 255 for the free end of the handle shaft 220.

A biased catch means 510 is conveniently housed in a recess 260 within the base of the support bracket 250. However, it is envisaged that the biased catch means 510 is located anywhere in the base of the support bracket 250, or is preferably co-formed therewith, provided that biased catch means 510 functions to enable locking bar 310 to be releasably retained in either the extended latched position or the retracted release position. The biased catch means 510 is preferably in the form of a resilient member made of plastic or a resilient metal and configured in such a manner as to engage and releasably retain the locking bar 310 via interaction with the catch means interaction region/s or zones 520 and 530. As illustrated, the biased catch means 510 is preferably in the form of an “M” wherein the outer legs of the M straddle the locking bar and are urged apart when the locking bar 310 is moved between the extended latched position and the retracted release position. In a further embodiment, the biased catch means 510 is co-formed with the support bracket 250.

However, alternative forms of biased catch means 510, for example, a ball-catch arrangement, are also envisaged. In all embodiments, the biased catch means 510 interacts with the locking bar 310 at a first catch means interaction region/s 520, when the locking bar is in an extended locking position and a second catch means interaction zone/s 530, when the locking bar 310 is in a retracted release position.

In alternative embodiments, the biased catch means 510 is locatable on the locking bar 310 and interacts with catch means interaction region/s or zone/s 520 and 530 on the support bracket 250.

The locking arrangement 100 of the present invention comprises a primary locking mechanism 300 and a secondary locking mechanism 400, which are used independently to move the locking bar 310 into a release position, thereby placing the T-handle assembly 200 in an unlocked condition.

In the illustrated embodiments of the present invention, the primary locking mechanism 300 further comprises an actuator 330, wherein the actuator 330 is operable by a vehicle's central locking system.

The actuator 330 as illustrated in the Figures is of the electromagnetic type, as is commonly used in the art of vehicle central locking systems. The actuator's internal operator mean(s) (not shown) is/are accommodated within a housing. A solenoid/motor is usually connected to the vehicle central locking system by wiring. However, should the actuator be pneumatically, hydraulically and/or mechanically actuated, suitable linkages other than the solenoid/motor as known in the art can be used to connect and act upon the actuator.

To a working end of the actuator 330, there is provided a coupling nose member 340. The nose member 340 protrudes from the actuator 330. The nose member 340 can couple with a lever 350, which lever is also connected to the locking bar 310, such that activation of the actuator 330 results in movement of the locking bar 310.

The actuator 330 operates in substantially the same plane as the locking bar 310, but in the illustrated embodiments, its direction of motion is substantially perpendicular to the direction of motion of the locking bar 310. Accordingly, in certain embodiments of the present invention, the actuator 330 is connected to the locking bar 310 via a pivoted lever 350.

In certain embodiments of the present invention, the primary locking mechanism 300 is substantially positioned under a cover 370, wherein the cover 370 comprises an opening 380 through which the locking bar 310 protrudes in order to engage with slot 235 in the slotted disc 230.

The secondary locking mechanism 400 is used independently of the primary locking mechanism 300 to move the locking bar 310 into position. For example, when the locking bar 310 is in the extended locking position, the secondary locking mechanism 400 is used to reversibly place the locking bar 310 in the retracted release position.

In order to interact with the locking bar 310, the secondary locking mechanism 400 comprises an override means 410. Preferably, the override means 410 is in the form of a cam. The override means 410 is configured to interact with respective regions of the locking bar 310. In particular, when the secondary locking mechanism is activated, the override means 410 is urged against a first 316 or second 318 shoulder of the locking bar 310 to reversibly move the locking bar 310 between the extended locking position and the retracted release position.

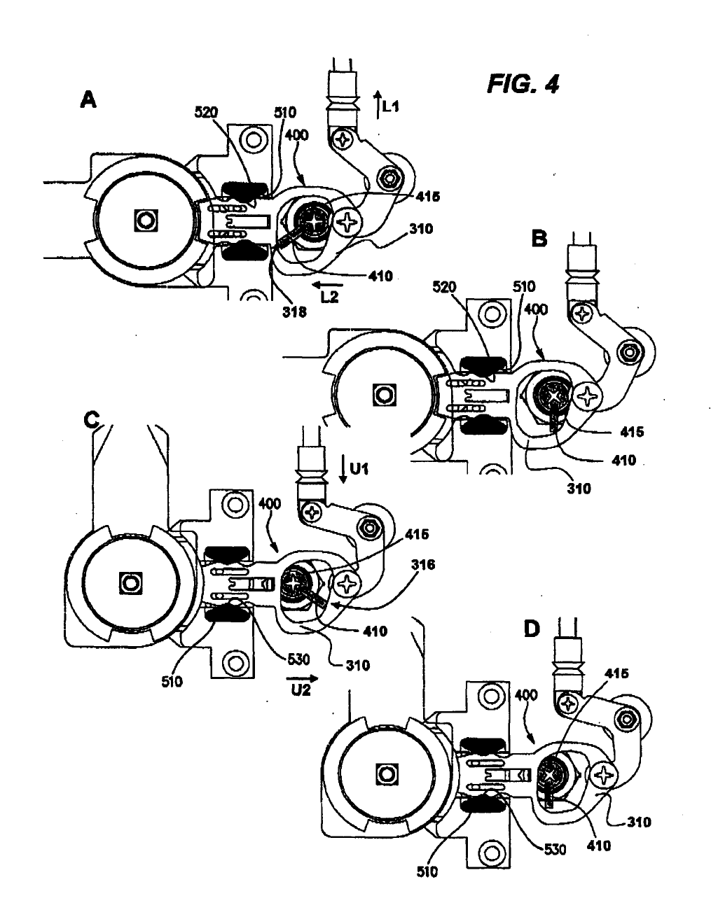

As illustrated in FIG. 4A, when the locking assembly 200 is in a latched and locked condition, the locking bar 310 is in the extended locking position and engages with slot 235 in the slotted disc 230. With the locking bar 310 in this position, the biased catch means 510 is engaged with the first catch means engagement region/s 520. In order to place the locking assembly 100 in an unlatched condition, it is necessary to first place the locking bar 310 in the retracted release position, such that the locking bar 310 is disengaged with the slot 235, which thereby permits rotation of the handle assembly 200. Movement of the locking bar 310 is either achieved via use of the primary locking mechanism 300 or the secondary locking mechanism 400.

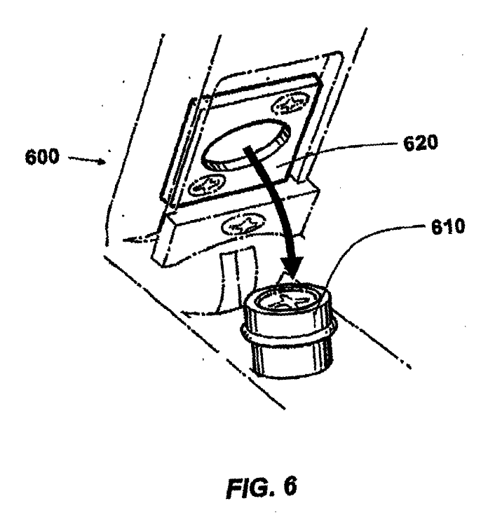

Preferred embodiments of the locking bar 310 and override means 410 are illustrated in FIG. 6. Activation of the secondary locking mechanism 400 brings the override means 410 into contact with the first shoulder 316 in order to place the looking bar 310 in the retracted release position (FIG. 4C). In this embodiment, the secondary locking mechanism 400 is in the form of a keyed lock, which comprises a biasing means 415 to return the secondary locking mechanism 400 to a reset position (FIG. 4D). In this form, the key is only removable from the keyed lock when the secondary locking mechanism 400 is in the reset position (FIG. 4B and FIG. 4D). In one form, the secondary locking mechanism 400 is rotated to bring the override means 410 into contact with the second shoulder 318 in order to place the locking bar 310 in the extended locking position (FIG. 4A). The biasing means 415 on the secondary locking mechanism 400 then returns the secondary locking mechanism 400 to a reset position (FIG. 4B). The locking bar 310 in the embodiment illustrated in FIG. 4 is adapted to allow free movement thereof by the primary locking mechanism 300 without the locking bar 310 contacting the override means 410.

Use of a primary locking mechanism 300 further comprising an actuator 330 is also shown in FIG. 4. Through activation of the actuator 330, via signals received by the solenoid/motor, the nose member 340 moves in the direction shown by arrow U1 (FIG. 4C), resulting in the overall length of the actuator 330 being increased beyond its “at rest” state and length. Such movement of the nose member 340 results in movement of the locking bar 310 in the direction of the arrow U2, via movement of the pivoted lever 350. With the locking bar 310 in the retracted release position, the biased catch means 510 engages the second catch means interaction zones 530. This action is equivalent to using the secondary locking mechanism 400 to urge the cam 410 against the first shoulder 316 to move the locking bar 310 to the retracted release position.

Accordingly, activation of the actuator 330 results in locking bar 310 being withdrawn from engagement with slot 235 in the slotted disc 230 to place the locking bar 310 in a retracted release position and thereby permit rotation of the handle 210 to place the T-handle assembly 200 in an unlatched condition.

In order to secure the locking assembly 100 of the present invention in a latched and locked condition, it is necessary to first place the handle assembly 200 in a latched condition, then place the locking bar 310 in the extended locking position, such that the locking bar 310 is engaged with the slot 235, thereby preventing rotation of the handle assembly 200. Movement of the locking bar 310 is achieved via use of either the primary locking mechanism 300 or the secondary locking mechanism 400.

Referring to FIG. 4A, upon receiving a signal, the solenoid/motor of the actuator 330 moves the nose member 340 in the direction indicated by arrow L1 whereby the overall length of the actuator 330 returns to its “at rest” state and length. Such movement of the nose member 340 results in movement of the locking bar 310 in the direction of the arrow L2, via movement of the pivoted lever 350. With the locking bar 310 in the extended locking position, the biased catch means 510 engages the first catch means interaction region/s 520. This action is equivalent to using the secondary locking mechanism 400 to urge the cam 410 against the second shoulder 318 to move the locking bar 310 to the extended locking position.

Accordingly, deactivation of the actuator 330 results in locking bar 310 being urged into engagement with slot 235 in the slotted disc 230 to place the locking bar 310 in an extended locking position and thereby preventing rotation of the handle 210 and retaining the handle assembly 200 in a latched condition.

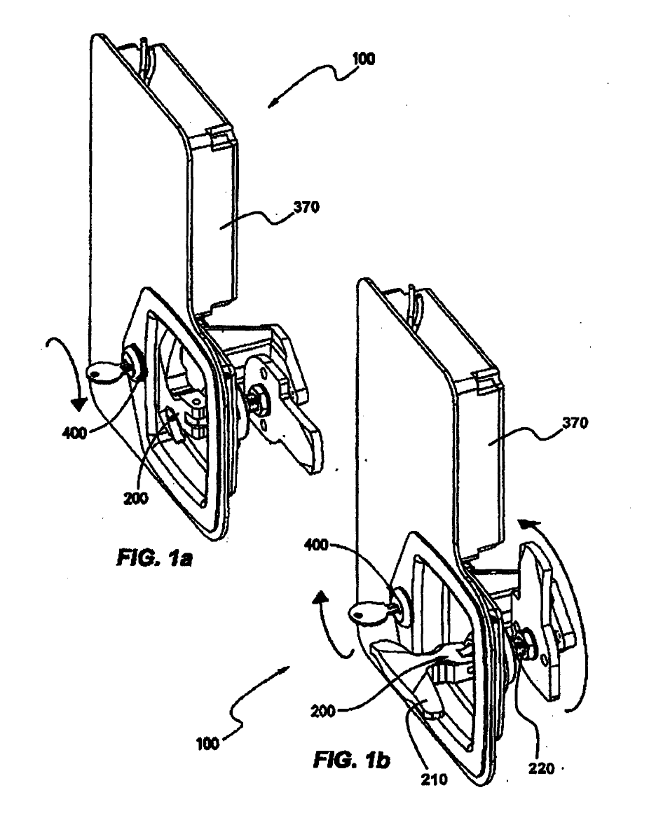

According to further preferred embodiments of the present invention, the T-handle assembly 200 further comprises an engagement means 600, wherein the engagement means 600 releasably engages the T-handle member 210 with the supporting dish 290 when the T-handle assembly 200 is in a closed condition and whereby the T-handle member 210 does not substantially protrude from the planar surface onto which the assembly is mounted, such as illustrated in FIG. 1a.

As shown in FIG. 6, the engagement means 600 is preferably a snap- or quick-fit engagement means comprising a male member 610, located on the dish 290, which is releasably receivable within a suitable female member 620, and which is located on the underside of the T-handle member 210.

The earlier disadvantages present in previous locking mechanisms can be minimized or at least substantially ameliorated by the present invention.

Where the terms “comprise”, “comprises”, comprised” or “comprising” are used in this specification, they are to be interpreted as specifying the presence of the stated features, integers, steps or components referred to, but not to preclude the presence or addition of one or more other feature, integer, step, component or group thereof.

Those skilled in the art will appreciate that although the invention described herein for simplicity's sake has referred in particular to delivery trucks, it has a general applicability to motor vehicles or lockable access points in general. It is to be understood that the invention includes all variations and modifications of the features identified, including all types of remote control devices, handles and locks referred to or indicated in the specification individually or collectively and any and all combinations of any two or more of said features.

1. A locking arrangement comprising:
(a) a handle assembly;
(b) a primary locking mechanism comprising a locking bar having a first shoulder and a second shoulder, which bar is movable between an extended locking position and a retracted release position, whereby when the locking bar is in the retracted release position, the handle assembly is movable between a latched condition and an unlatched condition;
(c) a secondary locking mechanism having an override means, wherein when the override means is independently urged against the first and/or second shoulder of the locking bar the locking bar is reversibly movable between the extended locking position and the retracted release position;
(d) an M-shaped biased catch means to releasably retain the locking bar in either the extended locking position or the retracted release position; and
(e) a support bracket, wherein the M-shaped biased catch means is housed within the support bracket.

2. The locking arrangement according to claim 1, wherein the locking bar further comprises a cut-out region to substantially receive the override means therein.

3. The locking arrangement according to claim 2, wherein the locking bar further comprises a first catch means interaction zone and a second catch means interaction zone, wherein when the locking bar is in the extended locking position, the biased catch means interacts with the first catch means interaction zone to releasably retain the locking bar in the extended locking position and when the locking bar is in the retracted release position, the biased catch means interacts with the second catch means interaction zone to releasably retain the locking bar in the retracted release position.

4. The locking arrangement according to claim 1, wherein the handle assembly is a T-handle assembly.

5. The locking arrangement according to claim 4, wherein the handle assembly comprises a handle, a handle shaft, a slotted disc and a latching cam, wherein the handle, the slotted disc and the latching cam are mountable or fixable to the handle shaft, so that rotation of the handle results in the concomitant rotation of the slotted disc and latching cam.

6. The locking arrangement according to claim 5, wherein the slotted disc comprises at least one slot with which the locking bar engages when in the extended locking position.

7. The locking arrangement according to claim 1, wherein the primary locking mechanism further comprises an actuator means which acts upon the locking bar to move the locking bar between the extended locking position and the retracted release position.

8. The locking arrangement according to claim 7, wherein the actuator of the primary locking mechanism is operable via a vehicle central locking system.

9. The locking arrangement according to claim 2, wherein the cut-out region is substantially ovoid and into which the override means of the secondary locking mechanism is substantially receivable to allow reversible movement of the locking bar between the extended locking position and the retracted release position.

10. The locking arrangement according to claim 1, wherein the secondary locking mechanism is a keyed lock.

11. The locking arrangement according to claim 10, wherein the secondary locking mechanism further comprises a biasing means to return the secondary locking mechanism to a reset position after the override means has been urged against the first or second shoulder of the locking bar.

12. The locking arrangement according to claim 11, wherein the key is removable from the secondary locking mechanism only when the secondary locking mechanism is in the reset position.

13. The locking arrangement of claim 3, wherein the M-shaped biased catch means comprises outer legs and wherein the outer legs straddle the locking bar and are urged apart when the locking bar is moved between the extended locking position and the retracted release position.
